(19) United States
(12) Patent Application Publication
(10) Pub. No.: US 2024/0017549 A1
(43) Pub. Date: Jan. 18, 2024

(54) LIQUID EJECTION APPARATUS, CONTROL METHOD FOR LIQUID EJECTION APPARATUS, AND STORAGE MEDIUM

(71) Applicant: CANON KABUSHIKI KAISHA, Tokyo (JP)

(72) Inventors: MASATAKA KATO, Kanagawa (JP); KAZUO SUZUKI, Kanagawa (JP); MASAKI NITTA, Kanagawa (JP); TAKESHI MURASE, Kanagawa (JP); HIROSHI TAIRA, Tokyo (JP); HIROSHI KAWAFUJI, Tokyo (JP); SAE MOGI, Kanagawa (JP)

(21) Appl. No.: 18/347,273

(22) Filed: Jul. 5, 2023

(30) Foreign Application Priority Data
Jul. 12, 2022 (JP) 2022-111796

(51) Int. Cl. B41J 2/165; B41J 2/045; B41J 29/393; B41J 2/175

(52) U.S. Cl. CPC B41J 2/16505; B41J 2/04553; B41J 2/16526; B41J 29/393; B41J 2/17596

(57) ABSTRACT

A liquid ejection apparatus includes: a liquid ejection head that ejects a liquid from an ejection port; and a cap movable to a closed position at which the cap covers the ejection port and an open position which is separated from the closed position and at which the ejection port is open. The liquid ejection apparatus further includes: a recovery unit configured to perform a recovery process of recovering liquid ejection performance of the liquid ejection head; and a determination unit configured to determine whether abnormal termination occurred with the cap at the open position when the liquid ejection apparatus resumes operating. In a case where the determination unit determines that the abnormal termination occurred, the recovery process is controlled based on a temperature obtained by a temperature obtaining unit.

### BACKGROUND OF THE INVENTION

### Field of the Invention

The present disclosure relates to a liquid ejection apparatus equipped with a liquid ejection head that ejects a liquid.

### Description of the Related Art

Liquid ejection apparatuses such as inkjet printing apparatuses are provided with a capping mechanism capable of covering a liquid ejection head's ejection ports in a tightly closed manner in order to suppress thickening and solidification of liquids in the liquid ejection head and thus prevent defective ejection at the ejection ports. Such a liquid ejection apparatus sometimes experiences abnormal termination in which the print head stops operating without being capped and the power gets turned off due to the occurrence of power outage, defective conveyance of the print medium, or the like during a printing operation. In a case where such abnormal termination occurs, the ejection ports of the liquid ejection head are exposed to the atmosphere. This leads to a possibility that the inks inside the liquid ejection head may thicken and solidify. To address this, in a case where the power is turned on after abnormal termination, the liquid ejection apparatus performs a maintenance process including a suction process of forcibly sucking and discharging the thickened liquids out of the liquid ejection head, a wiping process of wiping the ejection port surface in which the ejection ports are formed, preliminary ejection of preliminarily ejecting the liquids, and so on.

In the liquid ejection head, the thickening of the liquids progresses the longer the time for which the liquid ejection head is left uncapped due to abnormal termination (cap open time). Accordingly, the amount of the liquids to be sucked and the amount of the preliminary ejection necessary for to recover the ejection performance of the liquid ejection head increase as well.

Japanese Patent Laid-Open No. 2004-230646 discloses a technique in which a maintenance process is performed according to the cap open time to maintain the ejection performance of the liquid ejection head for images and prevent excessive liquid consumption.

However, in the case where a maintenance process is performed according to the cap open time as in Japanese Patent Laid-Open No. 2004-230646, the ejection performance of the liquid ejection head may be recovered to a varying extent, and the cause of this is found to be the difference in the temperature of the liquids inside the print head at the abnormal termination. Specifically, even if the cap open time after the abnormal termination is the same, the degree of thickening and solidification of the liquids will be greater in a case where the liquid temperature at the abnormal termination is high than in a case where the abnormal termination occurred with a low liquid temperature. For this reason, the amount of the waste liquids may be excessive or insufficient in the case of employing the method of controlling the amount of the waste liquids by a maintenance process solely based on the cap open time.

### SUMMARY OF THE INVENTION

An object of the present disclosure is to provide a technique capable of recovering the ejection performance of a print head more appropriately and efficiently even in a case abnormal termination occurs.

In a first aspect of the present disclosure, there is provided a liquid ejection apparatus, comprising: a liquid ejection head that performs an ejection operation of ejecting a liquid from an ejection port; a cap movable to a closed position at which the cap covers the ejection port and an open position at which the cap does not cover the ejection port; a temperature obtaining unit configured to obtain a temperature of the liquid ejection head; a recovery unit configured to perform a recovery process of recovering liquid ejection performance of the liquid ejection head; and a control unit configured to, in a case where a power of the liquid ejection apparatus is turned on after the power is turned off with the cap at the open position, control the recovery process based on the temperature obtained by the temperature obtaining unit before the power-off.

In a second aspect of the present disclosure, there is provided a control method of a liquid ejection apparatus including a liquid ejection head that ejects a liquid from an ejection port and a cap movable to a closed position at which the cap covers the ejection port and an open position which is separated from the closed position and at which the ejection port is open, the control method comprising: obtaining a temperature of the liquid ejection head; performing a recovery process of recovering liquid ejection performance of the liquid ejection head; and in a case where a power of the liquid ejection apparatus is turned on after the power is turned off with the cap at the open position, controlling the recovery process based on the obtained temperature before the power-off.

In a third aspect of the present disclosure, there is provided a non-transitory computer-readable storage medium storing a program for causing one or more processors of a computer to execute a control method of a liquid ejection apparatus including a liquid ejection head that ejects a liquid from an ejection port and a cap movable to a closed position at which the cap covers the ejection portand an open position which is separated from the closed position and at which the ejection port is open, the control method comprising: obtaining a temperature of the liquid ejection head; performing a recovery process of recovering liquid ejection performance of the liquid ejection head; and in a case where a power of the liquid ejection apparatus is turned on after the power is turned off with the cap at the open position, controlling the recovery process based on the obtained temperature before the power-off.

Further features of the present invention will become apparent from the following description of exemplary embodiments with reference to the attached drawings.

### BRIEF DESCRIPTION OF THE DRAWINGS

FIGS. 1A and 1B are an exterior perspective view and a side view illustrating a schematic configuration of a printing apparatus in an embodiment;

FIG. 2 is a block diagram illustrating a configuration of a control system in the printing apparatus;

FIG. 3 is a perspective view schematically illustrating a configuration of a print head;

FIG. 4 is a perspective view schematically illustrating a configuration of a recovery unit;

FIG. 5 is a diagram schematically illustrating channel configuration of the print head and a buffer tank;

FIG. 6 is a cross-sectional perspective view illustrating a configuration of a head chip;

FIG. 7 is a plan view illustrating ejection ports in a head chip and components around them;

FIG. 8 is a flowchart illustrating a printing operation sequence in a first embodiment;

FIG. 9 is a flowchart illustrating a power-on sequence [I];

FIG. 10 is a flowchart illustrating a maintenance operation in the first embodiment;

FIG. 11 is a diagram illustrating pump driving conditions in cleaning in the first embodiment;

FIG. 12 is a flowchart illustrating a printing operation sequence in a second embodiment;

FIG. 13 is a flowchart illustrating a printing operation sequence in a third embodiment;

FIG. 14 is a flowchart illustrating a power-on sequence [II]; and

FIGS. 15A and 15B are diagrams illustrating conditions for selecting cleaning in the third embodiment.

### DESCRIPTION OF THE EMBODIMENTS

Embodiments according to the present disclosure will be described in detail below with reference to the drawings. The following embodiments do not limit the present invention according to the claims, and not all the combinations of the features described in these embodiments are necessarily essential for the solution provided by the present invention.

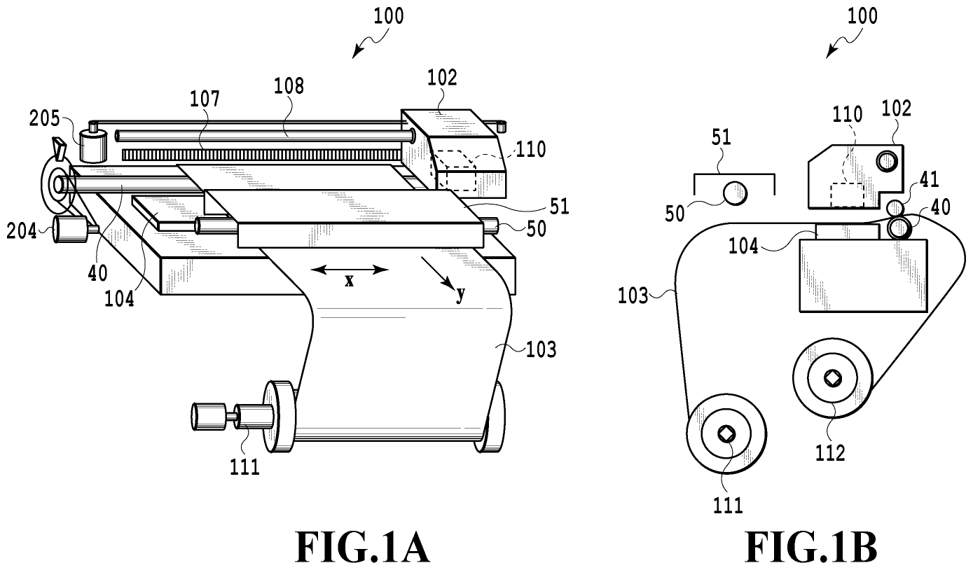

FIGS. 1A and 1B illustrate an inkjet printing apparatus as a liquid ejection apparatus according to an embodiment (hereinafter simply referred to also as “printing apparatus”). FIG. 1A is an exterior perspective view of a printing apparatus 100, and FIG. 1B is a side view of the printing apparatus 100. The printing apparatus 100 illustrated in FIGS. 1A and 1B is a so-called serial printing apparatus that prints an image by scanning a print head 110 in an x direction (scanning direction) perpendicular to a y direction of a print medium 103 (conveyance direction).

The printing apparatus 100 is supplied with the print medium 103, which has a long strip shape, from a spool 112 (see FIG. 1B) around which the print medium 103 is wound. Specifically, the print medium 103 fed from the spool 112 is nipped between a conveyance roller 40 and a pinch roller 41 and sent to a printing position on a platen 104 (the scanning region for the print head) by rotation of the two rollers 40 and 41. The conveyance roller 40 operates together with a conveyance motor 204 via a transfer mechanism, such as a belt and gears, and rotates with a driving force from the conveyance motor 204 to convey the print medium 103 in the y direction.

The printing apparatus 100 is provided with a carriage 102 that reciprocally moves (is reciprocally scanned) along a guide shaft 108 extending in a main scanning direction (x direction) perpendicular to the conveyance direction (y direction) with a driving force from a carriage motor 205. On the carriage 102, the print head (liquid ejection head) 110 to be described later is mounted, in which multiple ejection ports for ejecting liquids are arrayed. Thus, the print head 110 is reciprocally scanned along the main scanning direction together with the carriage 102. In the present embodiment, a carriage belt is used as a motive power transfer mechanism to transfer a driving force to the carriage 102 from the carriage motor 205, but the motive power transfer mechanism is not limited to this belt. A lead screw extending in the x direction can be rotated by the carriage motor 205 to move the carriage 102 engaged with the lead screw in the x direction.

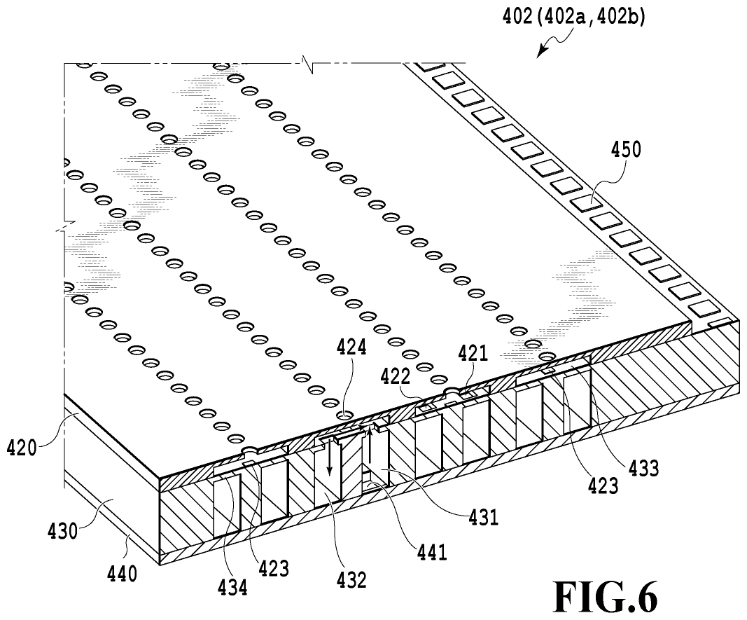

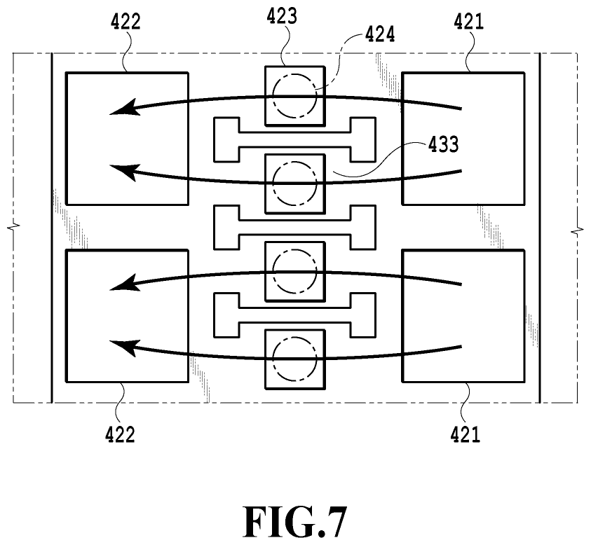

The print head 110 ejects inks (liquids) from the ejection ports at timings that are based on a position signal obtained from a linear encoder 107 while a main scan is performed. The print head in the present embodiment uses electrothermal conversion elements (heaters) 423 (see FIGS. 6 and 7) as energy generation elements that generate ejection energy for ejecting the inks from the ejection ports (hereinafter referred to also as “ejection elements”). The ejection elements 423 are disposed at positions opposed to ejection ports 424 (see FIGS. 6 and 7). Each ejection element 423 is driven according to print data indicating ejection or non-ejection of the ink from the corresponding ejection port 424, and generates a bubble in the ink with heat which the ejection element 423 generates by being driven. The generation of the bubble causes a pressure change, thereby ejecting the liquid from the ejection port. Instead of the electrothermal conversion element (heater), an electromechanical conversion element, such as a piezoelectric element, is usable as the ejection element 423.

An image with a given width corresponding to the range across which the multiple ejection ports 424 are arrayed (hereinafter referred to as “band width”) is printed on the print medium 103 in a single main scan of the print head 110. After an image with a single band width is formed, the print medium 103 is conveyed by a predetermined distance in the y direction by the conveyance motor 204. The print head 110 is then scanned in the main scanning direction again along with the carriage 102 to perform printing on the print medium. By repeating a main scan of the print head 110 and an operation of conveying the print medium 103 as above, predetermined images are formed on the print medium 103.

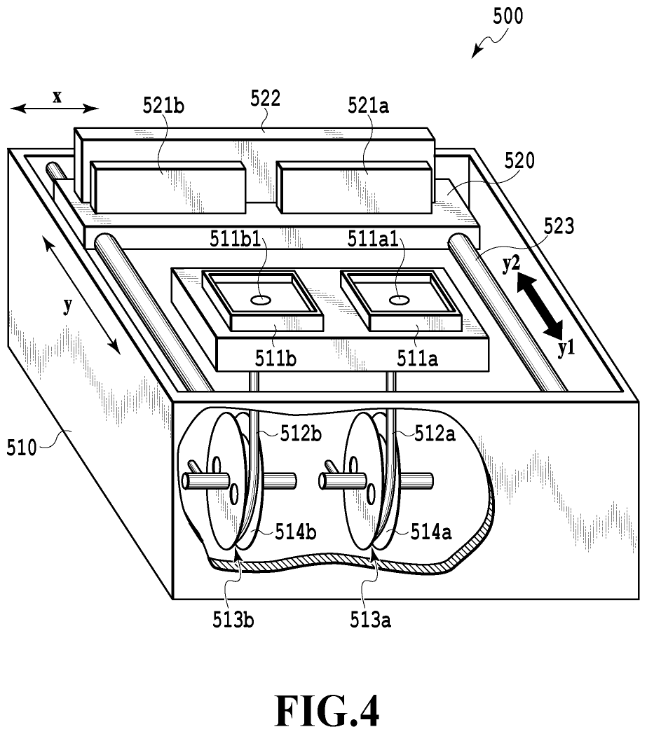

In a standby state before starting a printing operation or in a state where a printing operation is stopped, the carriage 102 is located at a home position set at one end of a main scan region. At this time, the print head 110 faces a recovery unit 500 (see FIG. 4) provided outside a printing region in which printing is performed on the print medium 103, and ejection port surfaces are covered (capped) with later-described caps provided to the recovery unit 500.

In a case of starting a printing operation, caps 511 are separated from the ejection port surfaces of the print head 110 to thereby bring the print head 110 into a scannable state. Then, print data corresponding to a single scan is loaded to a buffer, and the carriage 102 is scanned in the main scanning direction by the carriage motor 205 while the print head 110 is driven according to the print data to eject the inks. As a result, printing is performed on the print medium.

In the printing apparatus 100, a heater 50, which is supported on a frame member of the printing apparatus 100, is disposed at a position downstream of the region in which the print head 110 performs main scans (main scan region) in the conveyance direction (y direction). The heater 50 generates heat for fixing the inks applied to the print medium 103. The heater 50 is covered with a heater cover 51. The heater cover 51 has a function of efficiently applying the heat of the heater 50 onto the print medium 103 and a function of protecting the heater 50. The heater 50 is a sheathed heater, a halogen heater, or the like, for example. The print medium 103 having passed the heater cover 51, so that the inks are fixed, is wound around a take-up spool 111 to thereby be in the form of a roll-shaped web medium. The print medium having passed the heater cover 51 can be cut along the region where the image is formed with a knife not illustrated.

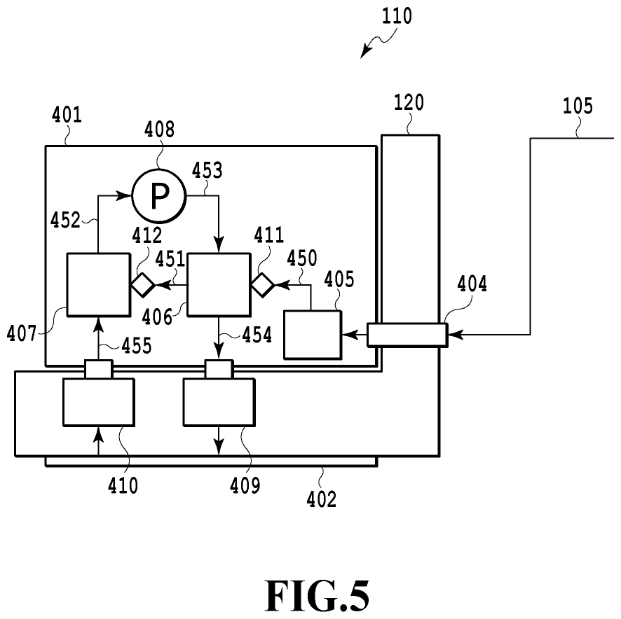

The inks to be supplied to the print head 110 are supplied to the print head 110 through respective supply tubes 105 (see FIG. 5) from respective ink tanks not illustrated which are provided inside or outside the main body of the printing apparatus 100. The inks can be supplied to the print head 110 from the ink tanks by pressurizing the inks inside the ink tanks with respective pressurization units. Also, the inks inside the ink tanks can be supplied (filled) into the print head 110 by capping the ejection port surfaces of the print head 110 with the caps 511 of the recovery unit 500 and generating a negative pressure inside the caps with respective suction pumps 513 communicating with the caps (see FIG. 4).

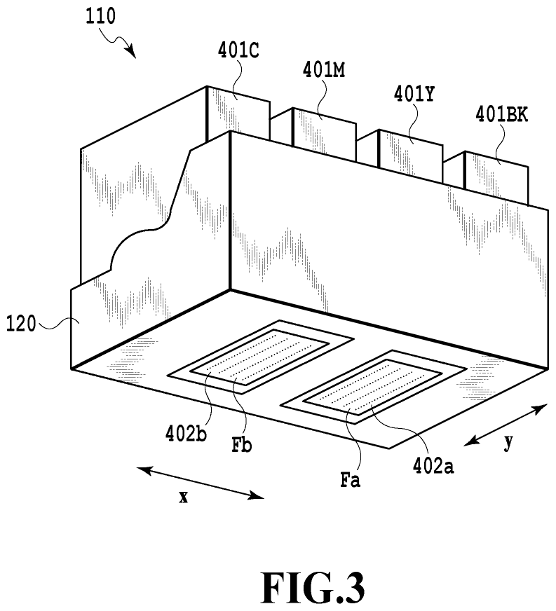

The print head 110 has one or more head chips including an ejection port array for each type (color) of ink to be used. The ejection port array is formed of multiple ejection ports 424 (see FIG. 7) arrayed in the conveyance direction (y direction). The print head 110 in the present embodiment includes two head chips 402a and 402b (see FIG. 3) to be described later.

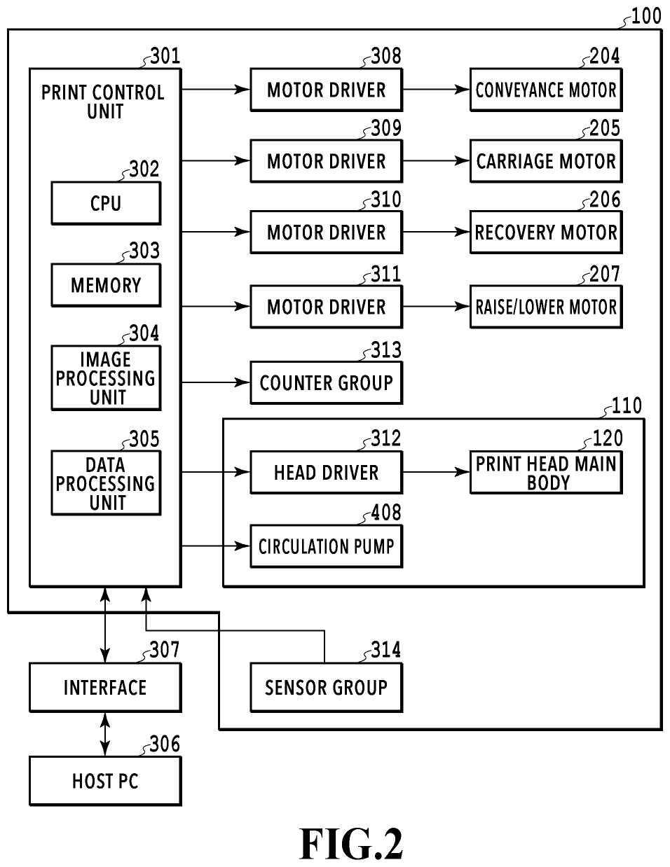

FIG. 2 is a block diagram illustrating a configuration of a control system in the printing apparatus 100 illustrated in FIGS. 1A and 1B. The printing apparatus 100 is connected to a data supply apparatus such as a host computer (hereinafter “host PC”) 306 via an interface 307. Image data, control signals related to printing, and the like sent from the host PC 306 are input into a print control unit 301 of the printing apparatus 100. The print control unit 301 includes a memory 303 storing the input image data, a program for executing later-described control, and the like. The print control unit 301 includes a CPU 302 that performs various calculation processes and controls components of the printing apparatus 100 in accordance with the program stored in the memory 303. The print control unit further includes an image processing unit 304 that performs image processing on the image data in conjunction with the CPU 302, a data processing unit 305, and the like.

The CPU 302 functions as a control unit that controls, for example, the conveyance motor 204, the carriage motor 205, a recovery motor 206, and a raise/lower motor 207 via motor drivers 308 to 311, respectively. The CPU 302 further functions as a first determination unit and a second determination unit that perform determination processes in later-described processes and a time obtaining unit that obtains an elapsed time. The conveyance motor 204 is a motor that rotationally drives the conveyance roller 40 for conveying the print medium 103, and forms a conveyance unit with the conveyance roller 40. The carriage motor 205 is a motor for reciprocally moving the carriage 102 carrying the print head 110. The recovery motor 206 is a motor mounted on the recovery unit 500. This recovery motor 206 is a driving source for causing the later-described suction pumps 513 and wiper holder 520 to operate. Specifically, a driving force from the recovery motor 206 is switched between and transferred to the suction pumps 513 and the wiper holder 520 by a cam shaft not illustrated. The raise/lower motor 207 is a motor for driving a raise/lower mechanism that raises and lowers the later-described caps 511.

The motor drivers 308, 309, 310, and 311 are drivers that rotationally drive the conveyance motor 204, the carriage motor 205, the recovery motor 206, and the raise/lower motor 207, respectively. A head driver 312 is a driver that drives the head chips 402a and 402b (see FIG. 3) provided to a print head main body 120.

A counter group 313 includes multiple counters that count signals output from the print control unit 301. For example, the counter group 313 includes a recovery process counter that, in a case where the inks are forcibly discharged from the print head 110, measures the amount of the inks discharged, and a preliminary ejection counter that counts the number of times preliminary ejection is performed before starting printing, at the end of the printing, and during the printing operation. The counter group 313 further includes a marginless printing ink counter that counts inks printed outside a region on the print medium in a case of performing marginless printing.

A sensor group 314 is connected to the print control unit 301. The sensor group 314 includes various sensors such as a head temperature sensor that detects the temperature of the print head 110 (temperature obtaining unit), an encoder sensor that is fixed to the carriage, a temperature/humidity sensor that detects temperature and humidity as use environments of the printing apparatus 100.

The CPU 302 of the print control unit 301 controls the driving of the motors via the respective motor drivers described above according to control signals input via the interface 307. The CPU 302 and the image processing unit 304 perform image processing on input image data to generate print data indicating ejection and non-ejection of the inks from the print head 110. The CPU 302 controls the driving of the print head main body 120 via the head driver 312 according to the generated print data to thereby control the ink ejection of the print head 110.

FIG. 3 is a perspective view illustrating a configuration of the print head 110 in the present embodiment. The print head 110 includes the print head main body 120 and buffer tanks (liquid holding unit) 401 that supply the inks to the print head main body 120. In the present embodiment, four independent buffer tanks 401C, 401M, 401Y, and 401BK corresponding to inks of four colors of cyan, magenta, yellow, and black are provided as the buffer tanks 401. The buffer tanks 401C, 401M, 401Y, and 401BK are communicatively connected to respective channels in the print head main body 120 corresponding to the respective ink colors. In FIG. 3, the buffer tanks are depicted to be visible for sake of illustration. In reality, the buffer tanks 401C, 401M, 401Y, and 401BK are accommodated to be covered by a housing of the print head 110. The head chips 402a and 402b having ejection port groups corresponding to the four respective types of ink are disposed in the lower surface of the print head main body 120.

In each of the head chips 402a and 402b, two arrays of 1024 ejection ports are formed per color at 1200 dpi intervals lying next to each other. Specifically, in each of the head chips 402a and 402b, a nozzle group including four nozzle arrays is formed, and the head chips 402a and 402b are each capable of ejecting inks of two colors. Thus, the print head 110 is capable of printing full-color images with the inks of the four colors ejected from the two head chips 402a and 402b.

In the present embodiment, an example in which four ejection port arrays are disposed in each of the head chips 402a and 402b has been described, but the present embodiment is not limited to this example. The number of head chips, the number of ejection port groups provided to each head chip, the number of ejection port arrays forming each ejection port group, the number and density of the ejection ports forming each ejection port array, and the like can be designed and changed as necessary. For example, an ejection port group for the four colors can be disposed in a single head chip. Alternatively, a head chip may be provided per ink color. Still alternatively, an ejection port group for a single color can be formed of a single ejection port array including multiple ejection ports disposed in a single straight line. Yet alternatively, an ejection port group for a single color can be formed of three or more ejection port arrays disposed in parallel to one another. For example, an ejection port group for a single color may be formed by disposing four ejection port arrays in parallel to one another in each of which 511 ejection ports for ejecting an ink of the same color are disposed in a straight line at 600 dpi intervals. In this case, the ejection ports of each ejection port array may be disposed such that their positions in the y direction are offset by 2400 dpi from those in another ejection port array. This enables a single ejection port group to form an image at a resolution of 2400 dpi.

FIG. 4 is a perspective view schematically illustrating a configuration of the recovery unit (recovery unit) 500 according to the present embodiment. The recovery unit 500 includes two caps 511a and 511b that face the two head chips 402a and 402b (see FIG. 3) of the print head 110, respectively, in a case where the print head 110 is at the home position at an end of the main scan region. The caps 511a and 511b are supported by the raise/lower mechanism not illustrated so as to be capable of being raised and lowered, and move between a raised position (closed position) and a lowered position (open position). At the raised position, the caps 511a and 511b are in tight contact with the lower surface of the print head 110 in which the head chips 402a and 402b are disposed, thus covering (capping) ejection port surfaces Fa and Fb (FIG. 3) of the print head. Capping the ejection port surfaces Fa and Fb makes it possible to prevent exterior damage to the ejection port surfaces Fa and Fb and also prevent evaporation of the volatile component in the inks through the ejection ports 424 in the head chips 402a and 402b and thereby suppress thickening and solidification of the inks.

Suction orifices 511a1 and 511b1 are formed at the bottoms of the caps 511a and 511b, respectively. Tubes 512a and 512b communicating with suction pumps 513a and 513b are connected to these suction orifices 511a1 and 511b1, respectively. The caps 511a and 511b are connected to an opening/closing valve not illustrated through the tubes. The opening/closing valve is also called an atmospheric valve. Performing the capping with this atmospheric valve closed will block the communication between the spaces inside the caps 511a and 511b and the space outside the caps (atmosphere). Thus, the inks are sucked out of the nozzles by performing the capping and driving the later-described suction pumps 513a and 513b with the atmospheric valve closed. Driving the suction pumps in the capped state with the atmospheric valve opened will discharge the inks in the caps 511a and 511b without sucking the inks out of the ejection ports 424. In a case of performing a printing operation, the caps 511a and 511b are held at a position where they are separated from the head chips 402a and 402b (lowered position) in order to avoid interference with the print head 110 moving along with the carriage 102.

The suction pumps 513a and 513b in the present embodiment are tube pumps. The tube pumps 513a and 513b respectively include: holding portions not illustrated on which are formed curved surface portions to hold part of the tubes 512a and 512b connected to the caps 511a and 511b; and rotation members 514a and 514b which rotatably support pressing rollers not illustrated. These rotation members 514a and 514b are rotated by the recovery motor 206 (FIG. 2). The rotation of the rotation members 514a and 514b causes the pressing rollers to move while squeezing the tubes 512a and 512b, thereby transferring the fluids (inks and gas) in the tubes 512a and 512b toward the discharge side. As a result, a negative pressure is generated inside the caps 511 in the capping state. In a case where the atmospheric valve is closed at this time, the inks are sucked out of the ejection ports 424 in the head chips 402a and 402b, and the sucked inks are discharged into a waste ink absorbing member not illustrated through the tubes 512a and 512b. By this discharge operation, thickened and solidified inks, inks containing dust and bubbles, and the like present in the ejection ports 424 are discharged. Accordingly, the ejection performance of the ejection ports 424 is recovered to an appropriate condition.

The suction operation with the suction pumps 513a and 513b is performed also in a case of discharging the inks received in the caps 511 as a result of preliminary ejection into the waste ink absorbing member through the tubes 512. For example, in a case where the inks received in the caps 511 as a result of preliminary ejection reaches a predetermined amount, the atmospheric valve is opened and the suction pumps 513a and 513b are driven. In this way, the inks received in the caps 511 are discharged into the waste ink absorbing member through the tubes 512. The suction operation using the caps 511a and 511b and the suction pumps 513a and 513b is performed also in a case of filling the inks into the print head 110 from the buffer tanks 401C, 401M, 401Y, and 401BK (initial filling).

The recovery unit 500 is provided with wipers 521a, 521b, and 522 that wipe the ejection port surfaces Fa and Fb of the head chips 402a and 402b. The wipers 521a, 521b, and 522 are made of an elastic material, such as rubber. In the present embodiment, there are provided two wipers 521a and 521b that wipe the ejection port surfaces Fa and Fb of the two head chips 402a and 402b illustrated in FIG. 3, respectively, and one wiper 522 that wipes the two ejection port surfaces Fa and Fb. The wipers 521a, 521b, and 522 are fixed to the wiper holder 520. The wiper holder 520 is supported so as to be movable along guides 523 extending in the array direction of the ejection ports in the print head 110 (y direction).

By moving the wiper holder 520 in a y1 direction with the print head 110 located at a standby position (home position), the wipers 521a, 521b, and 522 move in contact with the ejection port surfaces Fa and Fb. As a result, the inks, dust, and the like attached to the ejection port surfaces Fa and Fb are wiped off. This operation will hereinafter be referred to as “wiping”. After this wiping is finished, the carriage 102 is moved in the x direction to retreat from the region in which the wiping is performed. Then, the wiper holder 520 is moved in a y2 direction to return the wipers 521a, 521b, and 522 to the original position (the position before the wiping).

In the present embodiment, the wipers 521a, 521b, and 522 are made of an elastic material, such as rubber, but may be made of a porous material that absorbs the inks. Alternatively, the wipers 521a, 521b, and 522 can be vacuum wipers capable of sucking the ejection port surfaces. In the present embodiment, the configuration is such that the wipers wipe the ejection port surfaces Fa and Fb (wiping) only while moving in the forward direction (y1 direction), but the present embodiment is not limited to this configuration. The wipers may wipe the ejection port surfaces Fa and Fb while moving in the forward direction (y1 direction) and also while moving in the backward direction (y2 direction). In the present embodiment, the wiping direction is the array direction of the ejection ports 424 in the print head 110 (y direction) but the configuration may be such that the wipers 521a, 521b, and 522 are moved in a direction crossing (perpendicular to) the y direction (x direction). Alternatively, the configuration may be such that the wipers 521a, 521b, and 522 are fixed and the carriage 102 moves in the main scanning direction (x direction) to wipe the ejection port surfaces Fa and Fb. Still alternatively, the configuration may be such that multiple wipers are used to perform wiping operations in different directions. In this case, each recovery unit may be disposed at a different position. For example, one recovery unit may be disposed near the standby position of the carriage 102, and another recovery unit may be disposed on the opposite side across the region in which to perform printing on the print medium.

As described above, in the present embodiment, one pair of caps 511a and 511b, one pair of suction pumps 513a and 513b, and one pair of wipers 521a and 521b are provided for the two head chips 402a and 402b. The configurations of each of these pairs of members are similar except that they handle different kinds of inks. For this reason, in a case where the pairs of members are individually referred to, the reference signs given to the respective members will be used. In a case where the pairs of members are comprehensively referred to, 511 will be used as a collective reference sign for the caps, 513 will be used as a collective reference sign for the pumps, and 521 will be used as a collective reference sign for the wipers.

FIG. 5 is a diagram schematically illustrating channel configurations of the print head 110 and a buffer tank 401. While the diagram illustrates a configuration of an ink channel for one color, in the present embodiment the buffer tanks 401C, 401M, 401Y, and 401BK corresponding to the inks of the four colors are provided, and channels for ejecting the inks of the four colors are formed in the print head 110.

The supply tube 105 is connected to a joint 404 of the print head 110 through the inside of the carriage 102. The joint 404 communicates with the buffer tank 401. The ink supplied to the supply tube 105 is supplied to the buffer tank 401 through the joint 404. In the buffer tank 401, the ink supplied from the joint 404 passes through a filter 405, a channel 450, and a valve 411 and reaches a first pressure control member 406. The first pressure control member 406 is connected to a second pressure control member 407 through a channel 451 and a valve 412. The second pressure control member 407 is connected to a circulation pump (driving unit) 408 through a channel 452, and the circulation pump 408 is connected to the first pressure control member 406 through a channel 453.

The valve 411 connected to an inlet port of the first pressure control member 406 and the valve 412 connected to an inlet port of the second pressure control member 407 are each configured to open in response to receiving a preset negative pressure. The negative pressure that opens the valve 412 at the inlet port of the second pressure control member 407 is set higher than the negative pressure that opens the valve 411 at the inlet port of the first pressure control member 406.

The head chip 402 is supplied with the ink from the first pressure control member 406 through a channel 454 and a common supply channel 409. The ink supplied into the head chip 402 flows into later-described supply channels communicating with one or more ejection port arrays disposed in the head chip 402. Part of the ink having flowed into the supply channels is supplied to the ejection ports in the ejection port arrays, whereas the remaining ink flows into the print head main body 120 through later-described collection channels formed in the head chip 402. The ink having flowed into the print head main body 120 passes through a common collection channel 410 formed in the print head main body 120 and returns to the second pressure control member 407 through a channel 455.

Now, a channel configuration inside the head chip 402 will be described. FIG. 6 is a cross-sectional perspective view illustrating a configuration of the head chip 402. FIG. 7 is a plan view illustrating ejection ports formed in the head chip 402 (402a, 402b) and components around them.

As illustrated in FIG. 6, the head chip 402 mainly includes an orifice plate 420, a substrate 430, and a cover plate 440, and has a configuration in which these are sequentially laminated from the front surface side. The ejection ports 424 are formed in the orifice plate 420, which is located on the outermost surface side of the head chip 402. The surface of the substrate 430 laminated to the orifice plate 420 (the surface facing the orifice plate 420) includes the ejection elements 423, which generate ejection energy for ejecting the inks, at positions opposed to the ejection ports 424. In the present embodiment, electrothermal conversion elements (heaters) are used as the ejection elements 423, as mentioned earlier.

The substrate 430 forms pressure chambers 433 between itself and the orifice plate 420. Also, in the substrate 430, supply channels 431 and collection channels 432 are formed which extend along the array direction of the ejection ports 424 (y direction). The supply channels 431 communicate with the pressure chambers 433 through inlet ports 421 formed in a top plate portion 434 of the substrate 430. The collection channels 432 communicate with the pressure chambers 433 through outlet ports 422 formed in the top plate portion 434. As illustrated in the plan view of FIG. 7, the inlet ports 421 and the outlet ports 422 are located on opposite sides of the ejection ports 424. In the present embodiment, as illustrated in FIG. 7, one inlet port 421 and one outlet port 422 are disposed for each two ejection ports 424. The numbers of inlet ports and outlet ports may be such that one inlet port and one outlet port are provided for each one ejection port 424 or one inlet port and one outlet port are provided for each three or more ejection ports 424.

The supply channels 431 and the collection channels 432 are covered by the cover plate 440. In the cover plate 440, supply opening portions 441 and collection opening portions (not illustrated) are formed. The supply channels 431 communicate with the supply opening portions 441, and the collection channels 432 communicate with the collection opening portions. One or more supply opening portions 441 are formed per supply channel 431. Similarly, one or more collection opening portions are provided per collection channel 432. The number of supply opening portions and the number of collection opening portions may be the same or different.

The inks supplied from the respective common supply channels 409 (FIG. 5) in the print head main body 120 flow into the supply channels 431 through the supply opening portions 441 of the cover plate 440, flow in the array direction of the ejection ports 424, and flow into the inlet ports 421. The inks then flow into the pressure chambers 433 from the inlet ports 421 and are filled in the pressure chambers 433 and the ejection ports 424. Moreover, the inks filled in the pressure chambers 433 flow into the collection channels 432 through the outlet ports 422 and flow into the respective common collection channels 410 in the print head 110 through the collection-side opening portions. The inks thus supplied into the head chip 402 are maintained at such a negative pressure as to form menisci near the opening portions of the ejection ports 424.

A method of supplying an ink to the print head 110 and a buffer tank 401 and a method of circulating the ink inside the print head 110 in the present embodiment will now be described. Being pressurized, the ink reaches the inside of the print head 110 through the supply tube 105 from the ink tank not illustrated, passes through the filter 405, and flows into the channel 450. In a state where the ink is filled at an appropriate negative pressure at which menisci are maintained in the ejection ports 424 as mentioned above, the valve 411 connected to the inlet port of the first pressure control member 406 is closed. Accordingly, the ink does not flow into the first pressure control member 406. However, in response to application of a strong negative pressure to the ejection ports 424, ejection of the ink from the ejection ports 424, or the like as a result of a suction operation by the caps 511 of the recovery unit 500, the negative pressure in the first pressure control member 406 rises, thereby opening the valve 411. Accordingly, the ink flows into the first pressure control member 406.

As illustrated in FIG. 5, the first pressure control member 406 and the second pressure control member 407 are connected to the circulation pump 408, and the ink flows from the second pressure control member 407 to the first pressure control member 406 through the circulation pump 408 in a case where the circulation pump 408 is driven. Accordingly, the negative pressure in the second pressure control member 407 rises, thereby opening the valve 412 communicating with the inlet port of the second pressure control member 407. As a result, the ink flows back into the second pressure control member 407 from the first pressure control member 406. At this time, a pressure difference is generated between the first pressure control member 406 and the second pressure control member 407. This pressure difference causes the ink to flow through the first pressure control member 406, the common supply channel 409, the supply opening portions 441, the supply channels 431, the inlet ports 421, and the pressure chambers 433 in this order, and part of the ink flows into the ejection ports 424. The remaining ink not supplied to the ejection ports 424 flows through the pressure chambers 433, the outlet ports 422, the collection channels 432, the opening portions 441, and the common collection channel 410 in this order and returns to the second pressure control member 407.

The negative pressure and flow velocity of the ink inside the ejection ports 424 are adjusted to be within such ranges as to keep a meniscus in each ejection port 424 by means of the flow rate of the pump, the pressure loss in the channel between the first pressure control member 406 and the second pressure control member 407, and the opening/closing forces of the valves 411 and 412.

As described above, the ink around the ejection ports 424 is caused to flow by driving the circulation pump 408. This prevents drying of the ink in the ejection ports 424 and rise in ink viscosity during a printing operation and suppresses deterioration in ink ejection performance from each ejection port 424.

Next, the inks used in the present embodiment will be described. In the present embodiment, pigment inks each of which contain a pigment and inks each of which, for example, does not contain a pigment but contains a component that reacts with the pigment all contain a water-soluble organic solvent. Moreover, these inks contain water-soluble fine resin particles, a reactant, a surfactant, and so on.

The inks usable in the present embodiment include inks containing “fine resin particles” in order to be fixed onto a non-permeable print medium. “Fine resin particles” mean fine particles made of a resin and having such a particle size as to be dispersible in an aqueous medium. The fine resin particles have a function of fixing a pigment onto a surface of a print medium by being heated to be melted and form a film (film formation) on the surface of the print medium.

A glass transition point Tg of the resin making up the fine resin particles is preferably 120° C. or lower and more preferably higher than 30° C. and lower than 80° C. If the glass transition temperature Tg of the resin is 30° C. or lower, the difference between the glass transition point Tg and room temperature will be small and the fine resin particles will be in a nearly melted state within the ink. This raises the viscosity of the ink inside the head and may lower image quality (such as coloration and sharpness) due to defective ink ejection. In a case where the glass transition point Tg of the resin is higher than 120° C., a large amount of heat will be needed at a heating/drying unit to melt the fine resin particles. This leads to a failure to melt the fine resin particles before the pigment agglutinates with evaporation of the water in the ink. As a result, the image quality (such as coloration) may drop.

The resin making up the fine resin particles is not particularly limited as long as its glass transition point Tg is within the above range. Specifically, examples include an acrylic resin, a styrene-acrylic resin, a polyethylene resin, a polypropylene resin, a polyurethane resin, a styrene-butadiene resin, a fluoroolefin-based resin, and the like. For example, the acrylic resin can be obtained by combining monomers of a (meth)acrylic acid alkyl ester, a (meth)acrylic acid alkyl amide, or the like via emulsion polymerization or the like. Also, the styrene-acrylic resin can be obtained by combining monomers of a (meth)acrylic acid alkyl ester, a (meth)acrylic acid alkyl amide, or the like and styrene via emulsion polymerization or the like. By the emulsion polymerization, an emulsion with fine particles of the above resin (fine resin particles) dispersed in a medium can be obtained.

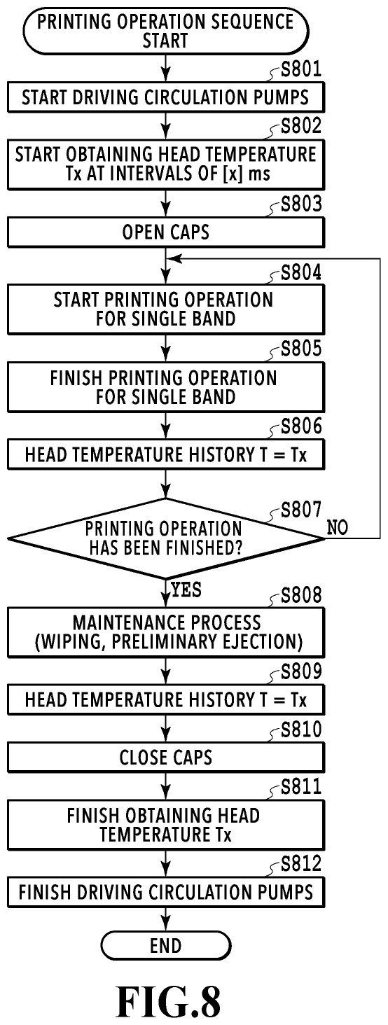

Next, a printing operation sequence executed in the present embodiment will be described with reference to the flowchart of FIG. 8. The CPU 302 of the printing apparatus 100 executes the processing to be described below in accordance with the program stored in the memory 303. Note that the letter S attached to each step number in the flowcharts to be referred to in the description of the present embodiment and the second and third embodiments to be described later (FIGS. 8, 9, and 12 to 14) represents a step.

In FIG. 8, in response to receiving print data, the CPU 302 launches each circulation pump 408 by driving a pump motor 408a via a motor driver 315 to (S801). Then, in S802, the CPU 302 starts obtaining a temperature Tx of the print head 110 (head temperature). The head temperature Tx is a value detected by a temperature sensor provided to the print head 110. The temperature sensor is a sensor included in the sensor group illustrated in FIG. 2, and is disposed at a position where the detected head temperature Tx is substantially equal to the ink temperature near the ejection ports. In the present embodiment, the head temperature Tx is obtained and updated regularly (at 16 millisecond (ms) intervals).

Then, in S803, the CPU 302 drives the raise/lower motor 207 via the motor driver 311 to cause the raise/lower mechanism not illustrated to operate so as to lower the caps 511. As a result, the caps 511 are separated from the print head 110 located at the home position. In other words, the caps 511 are brought into a non-capping state (cap open state). Thereafter, the CPU 302 starts a printing operation for a single band in S804 and finishes the printing operation for the single band in S805. The CPU 302 performs this printing operation for the single band by driving the carriage motor 205 via the motor driver 309 to move the carriage 102 in the main scanning direction and driving the ejection elements 423 based on the print data via the head driver 312. Thereafter, the CPU 302 stores the head temperature Tx obtained from the temperature sensor as a head temperature history T in a non-volatile memory area in the printing apparatus 100 (S806). The head temperature Tx stored as this head temperature history T is a temperature obtained and updated at 16 ms intervals. Specifically, it is the last head temperature Tx updated before the timing at which the head temperature history T is stored in the non-volatile memory area after finishing the printing operation for the single band.

Then, the CPU 302 proceeds to S807 and determines whether the printing operation has been finished. If the printing operation has not been finished, the CPU 302 proceeds to S804 and performs a printing operation for the next single band in S804 and S805 and updates the head temperature history T. Before proceeding to S804, the CPU 302 drives the conveyance motor 204 to perform a predetermined print medium conveyance operation. Also, if necessary, preliminary ejection is performed outside the printing region (e.g., in the caps 511) to discharge the inks having thickened due to evaporation of the volatile component in the inks (e.g., water) through the ejection ports 424. This prevents defective ejection. In the present embodiment, preliminary ejection is performed from each ejection port 424 a predetermined number of times (e.g., 16 droplets) before starting a printing operation, i.e., before performing various scans.

If determining in S807 that the printing operation has been finished, the CPU 302 executes a wiping process and preliminary ejection as a maintenance process in S808. Specifically, S808 includes performing wiping for wiping off the inks attached to ejection port surfaces F of the head chips 402 of the print head 110, and performing preliminary ejection into the caps 511 for removing the inks having entered the ejection ports 424 due to the wiping. In the present embodiment, preliminary ejection is performed to eject 1000 droplets from each ejection port. The CPU 302 performs the wiping by driving the recovery motor 206 via the motor driver 310 to move the wipers 521 along with the wiper holder 520 in the y direction. The maintenance process herein includes the wiping process and preliminary ejection as well as a recovery process of forcibly discharging the inks from the ejection ports 424 (cleaning) and the like.

Then, in S809, the CPU 302 updates the head temperature history T to the latest head temperature Tx. Thereafter, in S810, the CPU 302 drives the raise/lower motor 207 via the motor driver 311 to raise the caps 511 with the raise/lower mechanism such that the caps 511 come into tight contact with the print head 110 and thus is brought into a capping state (cap closed state). After the capping, the CPU 302 finishes obtaining and updating the head temperature Tx in S811. Thereafter, in S812, the CPU 302 stops the ink circulation by the circulation pump 408. This ends the printing operation sequence from S801 to S812. As described above, the printing operation sequence involves not only starting and finishing a printing operation but also obtaining the head temperature, setting the head temperature history, opening and closing the caps 511, performing a maintenance process (wiping, preliminary ejection), and so on.

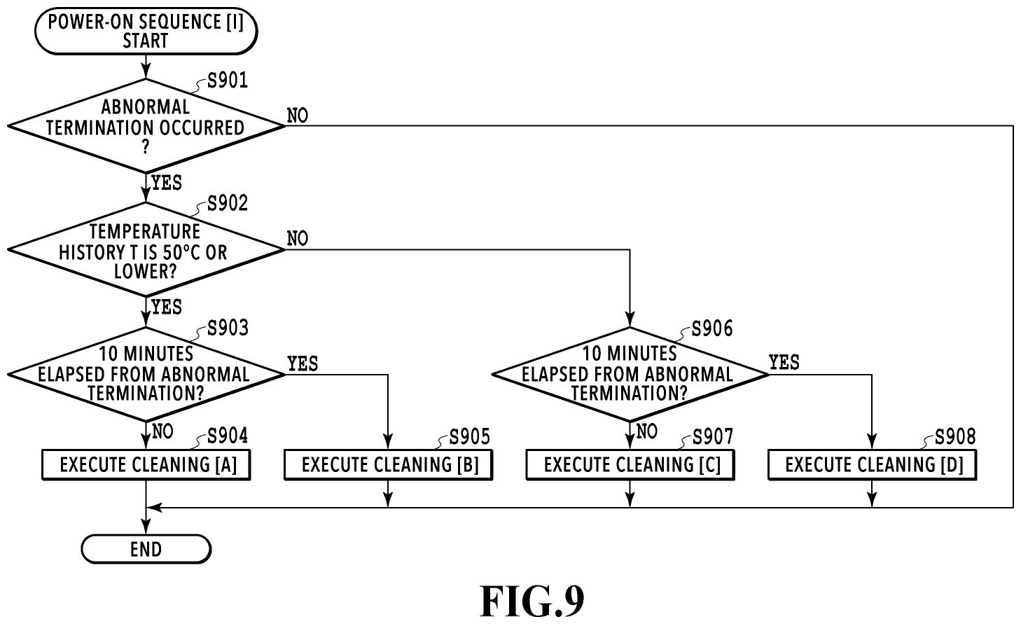

FIG. 9 is a flowchart for describing a sequence executed by the CPU 302 in the present embodiment in a case where the power is turned on (hereinafter referred to as “power-on sequence [I]”). In a case where the user presses a power button not illustrated which is provided in an operation panel of the printing apparatus 100 (turning on the power), the CPU 302 starts the power-on sequence [I] (first recovery control).

First, in S901, the CPU 302 determines whether abnormal termination occurred in the printing apparatus 100. Abnormal termination herein refers to a failure to normally terminate the operation of the printing apparatus 100 when the power was turned off last time. Specifically, it refers to a situation where the operation of the printing apparatus 100 has to stop due to power outage during the execution of the printing operation sequence in FIG. 8, or a situation where an error occurs due to a failure to normally convey the print medium as a result of a jam (a jam of the print medium) or the like during the execution of the printing operation sequence. In such a situation, the print head 110 is left uncapped. Thus, in the present embodiment, whether abnormal termination occurred is determined in S901 by detecting whether the print head 110 is capped. Specifically, if the print head 110 is capped, the CPU 302 determines that abnormal termination did not occur, and terminates the power-on sequence [I]. If the print head 110 is not capped, the CPU 302 determines that abnormal termination occurred, and proceeds to S902.

In the present embodiment, whether abnormal termination occurred in the printing apparatus 100 before the power-on is determined by detecting whether the print head 110 is capped at the power-on, as described above. However, whether abnormal termination occurred can be determined by another method. For example, whether the carriage 102 is located at the home position, which is the capping position, may be detected at the time of performing an operation of initializing the recovery unit 500 in response to power-on. Also, in a case where an error such as a jam occurs, an error flag may be enabled and the presence of the error flag may be checked at power-on to determine whether abnormal termination occurred.

The present embodiment assumes that the power of the printing apparatus 100 is temporarily turned off in a case where abnormal termination occurs. For example, the present embodiment assumes that, in a case where power outage occurs, the power is turned off and, in a case where a jam occurs, the power is turned off when an operation to solve the jam is performed. Thus, whether abnormal termination occurred is determined when the power is turned on, i.e., in a situation where abnormality that occurred in the printing apparatus 100 has been solved and the operation of the printing apparatus is to be resumed.

In a case where abnormal termination occurs, the caps 511 are separated from the print head 110, so that the ejection ports 424 of the print head 110 are open to the atmosphere (cap open state). Hence, the volatile component in the ink solvent may evaporate through the ejection ports 424 and cause thickening and solidification of the inks around the ejection ports 424. The degree of the ink thickening and solidification varies depending on the time elapsed since the last abnormal termination that occurred before turning on the power (before resuming the operation) until the power-on. That is, the degree of evaporation of the volatile component through the ejection ports 424 varies depending on the time elapsed since the occurrence of abnormal termination until the power-on. Moreover, in a case where the inks near the ejection ports 424 are exposed to a high temperature for a certain time or longer, it changes the degree of the ink thickening and film formation. Thus, in the present embodiment, the recovery process (cleaning) is performed according to the temperature history T of the print head and the time elapsed since abnormal termination to maintain the normal ejection condition.

First, in S902, the CPU 302 reads out the head temperature history T stored in the non-volatile memory and determines whether or not the head temperature history T is 50° C. or lower. The head temperature history T read out in S902 indicates the head temperature Tx immediately before the occurrence of the abnormal termination. If this head temperature history T is 50° C. or lower, then in S903, the CPU 302 obtains the time elapsed since the abnormal termination until the power-on, and determines whether or not the elapsed time is a predetermined time or longer. In the present embodiment, if the time elapsed since the occurrence of the abnormal termination until the power-on is 10 minutes or shorter, the CPU 302 proceeds to S904 and executes cleaning [A]. On the other hand, if the time elapsed since the abnormal termination is longer than 10 minutes in S903, the CPU 302 proceeds to S905 and executes cleaning [B]. As described above, in the present embodiment, the degree of evaporation of the volatile component through the ejection ports 424 varies depending on the time elapsed since the occurrence of abnormal termination, and therefore the type of cleaning to be executed is switched accordingly. The contents of each type of cleaning will be described later.

If, on the other hand, determining in S902 that the head temperature history T is higher than 50° C., the CPU 302 proceeds to S906 and determines the time elapsed since the occurrence of the abnormal termination until the power-on, as in S903. If the time elapsed since the occurrence of the abnormal termination until the power-on is 10 minutes or shorter, the CPU 302 executes cleaning [C] in S907. If, on the other hand, determining in S906 that the time elapsed since the occurrence of the abnormal termination until the power-on is longer than 10 minutes, the CPU 302 proceeds to S908 and executes cleaning [D].

As described above, as in the case where the head temperature history T is 50° C. or lower, in the case where the head temperature history T is determined to be higher than the type of cleaning to be executed is switched according to the time elapsed since the occurrence of the abnormal termination until the power-on and the temperature at the occurrence of the abnormal termination. In particular, in the present embodiment, the solvent in each ink contains water-soluble fine resin particles. For this reason, in a case where the ink is exposed to a high temperature for a certain time or longer, the solvent in the ink around the ejection ports 424 evaporates, thereby promoting transformation into a film (film formation). This increases the degree of the ink thickening and solidification. Thus, in the case where the head temperature history T is higher than 50° C. and the elapsed time is longer than 10 minutes, the cleaning [D] is executed, which is stronger than the cleaning [C] performed in the case where the elapsed time is 10 minutes or shorter.

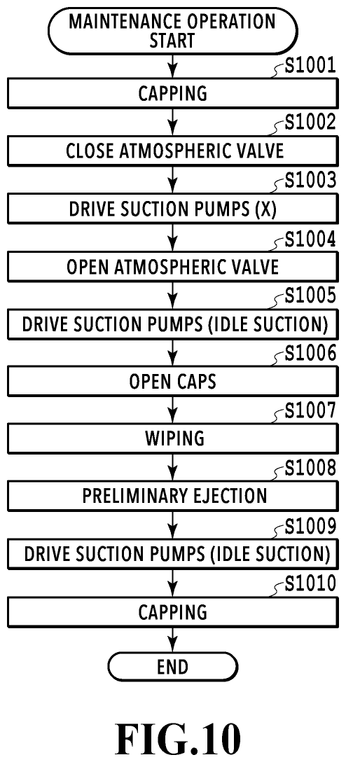

FIG. 10 is a flowchart for describing a maintenance operation executed in the present embodiment. The CPU 302 executes the operation to be described below by controlling components in accordance with the program stored in the memory 303.

In S1001, the CPU 302 performs a capping operation. This capping operation is performed by moving the print head 110 to a position opposed to the recovery unit 500 (home position) and then raising the caps 511 into contact with the print head 110. The CPU 302 moves the print head 110 to the home position by driving the carriage motor 205 via the motor driver 309. The CPU 302 raises the caps 511 by driving the raise/lower motor 207 via the motor driver 311 so as to cause the raise/lower mechanism to raise the caps 511.

Then, in S1002, the CPU 302 closes the atmospheric valve not illustrated, which is provided on the tubes connected to the caps 511. Then, in S1003, the CPU 302 drives the recovery motor 206 via the motor driver 310 to drive the suction pumps 513. Driving the suction pumps 513 generates a negative pressure in each of spaces formed by the respective caps 511 and the print head 110, i.e., each of spaces covering the respective head chips 402 of the print head 110, so that the inks are sucked out of the ejection ports 424 in the print head 110. The amount of the inks to be sucked out of the ejection ports 424 varies depending on the magnitude of the negative pressure generated in the spaces. The four types of cleaning [A], [B], [C], and [D] mentioned above differ from one another in this amount of the inks to be sucked out.

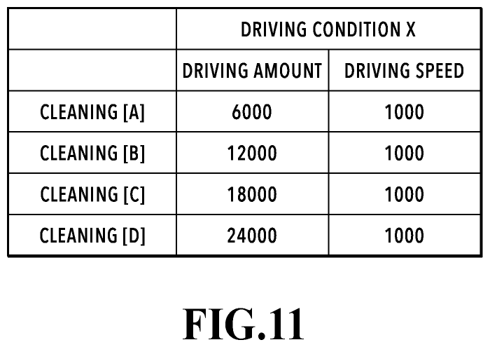

FIG. 11 illustrates a driving condition X for the suction pumps 513 in each of the four types of cleaning [A], [B], [C], and [D] executed in the present embodiment. The driving condition X is represented by the driving amount and driving speed of the suction pumps 513. The driving amount represents the amount of rotation of the recovery motor 206 for driving the suction pumps 513, and the driving speed represents the number of rotations per second. Here, an encoder sensor detects radially extending slits formed in an encoder scale of a rotary encoder mounted on a rotation shaft of the recovery motor 206, and the number of slits thus detected indicates the amount of rotation.

In the example illustrated in FIG. 11, in the cleaning [A], the ink suction is performed with the driving amount of the suction pumps 513 set at 6000 slits and the driving speed of the suction pumps 513 set at 1000 slits/sec. Similarly, in the cleaning [B], the ink suction is performed with the driving amount of the suction pumps 513 set at 12000 slits and the driving speed of the suction pumps 513 set at 1000 slits/sec. In the present embodiment, the amount of ink to be sucked per color in the cleaning [A] is approximately 1 g/color, and the amount of ink to be sucked per color in the cleaning [B] is approximately 1.5 g/color. As described above, in a case where the temperature history T, which indicates the temperature of the print head 110 near the ejection ports at abnormal termination, is 50° C. or lower, the evaporation and thickening of the inks inside the ejection ports 424 progress the longer the time elapsed until the power-on. For this reason, the cleaning [A], in which the amount to be sucked is the smallest, is executed in the case where the result of the determination in S903 described above indicates that the time elapsed since the abnormal termination is shorter than 10 minutes. The cleaning [B], in which the amount to be sucked is larger than that in the cleaning [A], is executed in the case where the elapsed time is 10 minutes or longer.

In the cleaning [C], the ink suction is performed with the driving amount of the suction pumps 513 set at 18000 slits and the driving speed of the suction pumps 513 set at 1000 slits/sec. In the cleaning [D], the ink suction is performed with the driving amount of the suction pumps 513 set at 24000 slits and the driving speed of the suction pumps 513 set at 1000 slits/sec.

In the present embodiment, the amount of ink to be sucked per color in the cleaning [C] is approximately 2 g/color, and the amount of ink to be sucked per color in the cleaning [D] is approximately 2.5 g/color. As illustrated in FIG. 9, the cleaning [C] and cleaning [D] are executed in the case where the temperature history T at the abnormal termination, i.e., the last head temperature detected before the abnormal termination, is higher than 50° C. In a case where the head temperature history T is a high temperature above 50° C., it is likely that the ink thickening and solidification near the ejection ports have progressed to a greater degree than in the case where the head temperature history is 50° C. or lower. Thus, in the case where the head temperature history T is higher than it is necessary to perform stronger cleaning for the print head 110 to recover its normal ejection performance. Hence, in the present embodiment, the cleaning [C] or the cleaning [D] is executed, in which the amount of the inks to be sucked is larger than those in the cleaning [A] and the cleaning [B]. Incidentally, the amount of the inks to be sucked to recover the ejection performance of the print head 110 corresponds to the strength of the cleaning (referred to also as “recovery strength”).

As described above, in the present embodiment, the recovery strength of the cleaning is controlled by controlling the driving time of the suction pumps, but another method may be employed. For example, the recovery strength may be controlled by controlling the driving speed. Alternatively, increasing the number of times to perform suction may be preferably employed as a method to control the recovery strength. Also, the number of times to perform wiping and preliminary ejection may be controlled according to the recovery strength of the cleaning. Specifically, the number of times to perform wiping and preliminary ejection may be set to increase the higher the recovery strength of the cleaning. In a case of increasing the recovery strength, the recovery time generally tends to be increase and the amount of the resulting waste inks generally increases as well. Hence, it is necessary to select and execute an optimal cleaning condition.

Now, refer back to FIG. 10. In S1004 after sucking the inks in S1003, the CPU 302 opens the atmospheric valve communicating with the caps 511 to allow communication between the spaces inside the caps 511 and the atmosphere outside the caps 511. Then, in S1005, the CPU 302 drives the suction pumps 513 via the motor driver 310. In the case of driving the suction pumps 513 with the spaces inside the caps 511 and the atmosphere communicating with each other, the external air is introduced into the caps through the atmospheric valve. Accordingly, the inks are not sucked out of the ejection ports 424 in the print head 110, but the inks accumulated in the caps 511 are sucked by the suction pumps 513 and discharged into the waste ink absorbing member. The suction operation by the suction pumps 513 without sucking the inks out of the print head 110 is also called “idle suction”. In the present embodiment, the idle suction by the suction pumps 513 is performed under a driving condition of 6000 slits as the driving amount and 1000 slits/sec as the driving speed.

Then, in S1006, the CPU 302 performs a cap opening operation. At this time, the CPU 302 drives the raise/lower motor 207 via the motor driver 311 to cause the raise/lower mechanism to operate so as to move the caps 511 downward. As a result, the caps 511 are separated from the ejection port surfaces F of the print head 110 and thus brought into the cap open state.

Thereafter, in S1007, the CPU 302 drives the recovery motor 206 via the motor driver 310 to move the wipers 521 and 522 in the y1 direction along with the wiper holder 520 to thereby wipe off ink droplets, small dust, and the like attached to the ejection port surfaces F (wiping). Then, in S1008, the CPU 302 drives the head driver 312 to drive the ejection elements provided in the head chips 402 so as to perform preliminary ejection. By this preliminary ejection, the inks of mixed colors present in the ejection ports 424 due to the wiping and the like are discharged. In the present embodiment, preliminary ejection of 10000 droplets is performed for each ejection port 424 into the corresponding cap 511.

Then, in S1009, the CPU 302 drives the recovery motor 206 via the motor driver 310 to drive the suction pumps 513 so as to discharge the inks ejected into the caps 511 out of the caps 511. In the present embodiment, in this discharge operation, the suction pumps 513 are driven under a driving condition of 6000 slits as the driving amount and 1000 slits/sec as the driving speed. Thereafter, in S1010, the CPU 302 drives the raise/lower motor 207 via the motor driver 311 to cause the raise/lower mechanism to raise the caps 511 to cap the print head 110. This ends the maintenance operation. In the case where the maintenance operation ends, the power-on sequence [I] illustrated in FIG. 9 ends.

In the present embodiment, a temperature sensor provided to the print head 110 is used to estimate the ink temperature inside the print head 110, but the ink temperature near the ejection ports can be estimated by another method. For example, the ink temperature near the ejection ports can be estimated based on print data indicating ejection and non-ejection of the inks or the like. Alternatively, the temperature near the ejection ports can be directly detected with a sensor. For example, a temperature sensor may be disposed in an ink channel in the print head 110.

In the present embodiment, taking into account that the thickened and solidified state of the inks inside the ejection ports changes depending on the temperature at abnormal termination (temperature history T), the head temperature Tx at abnormal termination is obtained as the head temperature history T, and cleaning with recovery strength corresponding to the head temperature history T is selected. Specifically, the cleaning [A] or [B] is selected in a case where the head temperature history T at the abnormal termination is a predetermined temperature (50° C.) or lower, and the cleaning [C] or [D] with higher recovery strength than those of the cleaning [A] and the cleaning [B] is selected in a case where the head temperature history T is higher than the predetermined temperature. In this way, it is possible to perform cleaning suitable for the temperature at the abnormal termination. Moreover, in the present embodiment, the cleaning is selected taking into account not only the head temperature at the abnormal termination but also the time elapsed since the abnormal termination until the power-on. Specifically, in the case where the head temperature history T is 50° C. or lower, the cleaning [A] is selected if the elapsed time has not reached a predetermined time (10 minutes) whereas the cleaning [B] with higher recovery strength than that of the cleaning [A] is selected if the elapsed time is the predetermined time or longer. In the case where the head temperature history T is higher than 50° C., the cleaning [C] is selected if the elapsed time has not reached the predetermined time whereas the cleaning [D] is selected if the elapsed time is the predetermined time or longer. By selecting cleaning taking into account the head temperature at the abnormal termination and the time elapsed since the abnormal termination until the power-on as described above, it is possible to achieve accurate cleaning corresponding to the change in the inks' state. Accordingly, it is possible to maintain the appropriate ejection performance of the print head 110 while lowering the running cost by reducing unnecessary ink discharge.

Note that the present disclosure is not limited to the above embodiment, and appropriate cleaning may be selected from among multiple types of cleaning differing in strength solely based on the head temperature at the abnormal termination (head temperature history T). Specifically, first cleaning may be selected in a case where the temperature history T is a predetermined temperature or lower, and second cleaning with higher recovery strength than that of the first cleaning may be selected in a case where the temperature history T is higher than the predetermined temperature. For example, in the case where the temperature history T is 50° C. or lower in S902 in FIG. 9, the cleaning [B] may be selected as the first cleaning. In the case where the temperature history T is higher than 50° C., the cleaning [D] may be selected as the second cleaning. The types of cleaning to be selected are not limited to [B] and [D] and may be other types of cleaning. Specifically, the recovery strength of the first cleaning and that of the second cleaning can be set as appropriate, for example, such that the recovery strength of the first cleaning is an average of the recovery strengths of the cleaning [A] and the cleaning [B] and the recovery strength of the second cleaning is an average of the recovery strengths of the cleaning [C] and the cleaning [D].

### Second Embodiment

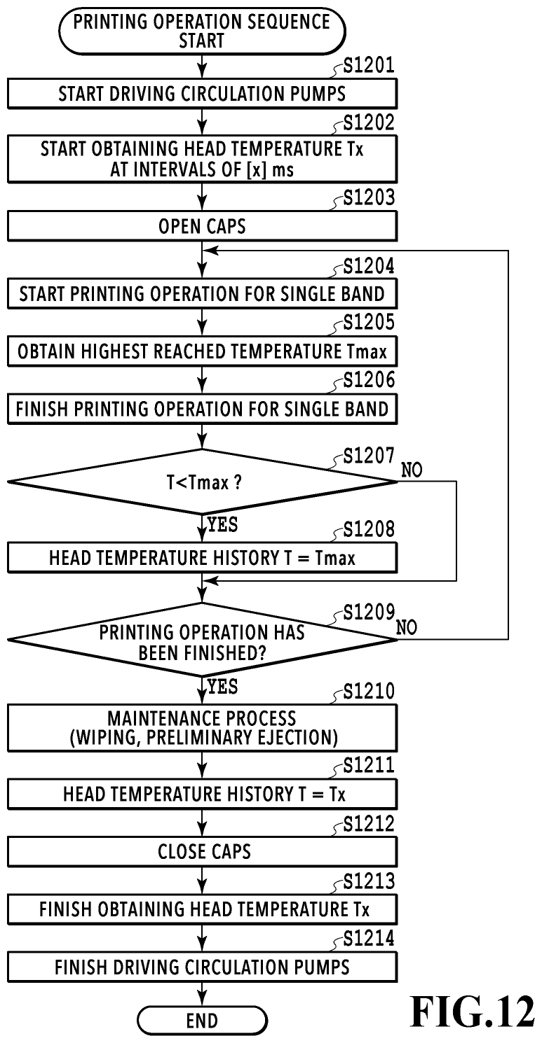

Next, a second embodiment of the present disclosure will be described. FIG. 12 is a flowchart illustrating a printing operation sequence performed in the present embodiment. In the following description in the present embodiment, processing differing from the printing operation sequence described in the first embodiment (FIG. 8) will be mainly described.

In a case where the printing apparatus 100 receives print data from the host PC 306, the CPU 302 starts the printing operation sequence illustrated in FIG. 12. The CPU 302 executes processes in S1201 for starting driving the circulation pump 408 to S1204 for starting a printing operation for a single band. The processes in S1201 to S1204 are similar to the processes in S801 to S804 in the first embodiment, and description thereof is therefore omitted.

In S1205, the CPU 302 obtains a highest reached temperature Tmax among the head temperatures Tx detected at 16 ms intervals during the printing operation for the single band. After finishing the printing operation for the single band in S1206, the CPU 302 determines whether the highest reached temperature Tmax is higher than the head temperature history T stored in the non-volatile memory area in the printing apparatus 100 (S1207). If the highest reached temperature Tmax is higher than the head temperature history T, the CPU 302 stores the highest reached temperature Tmax as the head temperature history T in the non-volatile memory area in S1208. Thereafter, the CPU 302 proceeds to a process S1209 of determining whether the printing operation has been finished.

If, on the other hand, determining in S1208 that the highest reached temperature Tmax is the head temperature history T or lower, the CPU 302 proceeds to S1209. Specifically, if the highest reached temperature Tmax is the head temperature history T or lower, the CPU 302 does not update the head temperature history T in S1208. The processes from S1209 (the processes in S1209 to S1214) are similar to the processes in S807 to S812 in the first embodiment, and description thereof is therefore omitted.

In the present embodiment, for each band, the CPU 302 does not update the head temperature history T unless the highest reached temperature Tmax exceeds the head temperature history T in the printing operation for the band as described above. This reduces the frequency of a writing process to the non-volatile memory area in the printing apparatus 100 and therefore reduces the load required for the processing. Accordingly, it is possible to lengthen the lifetime of electrical parts of the main body of the printing apparatus. Also, as the head temperature history at abnormal termination, the highest reached temperature during the preceding printing operation is stored. In this way, a recovery operation for recovering the ejection performance of the print head 110 to appropriate performance will not be insufficient.

### Third Embodiment

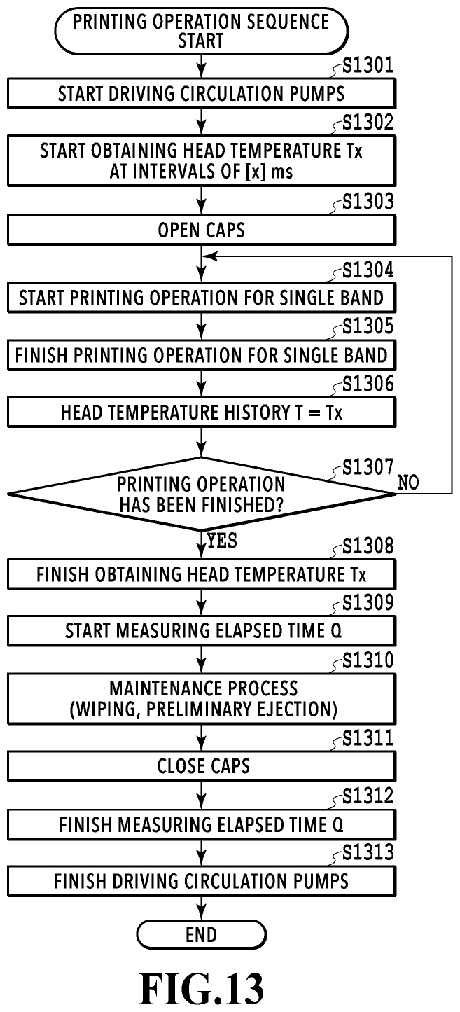

Next, a third embodiment of the present disclosure will be described. FIG. 13 is a flowchart illustrating a printing operation sequence performed in the present embodiment. The processes in S1301 to S1307 in FIG. 13 are similar to the processes in S801 to S807 in the first embodiment, and description thereof is therefore omitted.

In the present embodiment, if determining in S1307 that the printing operation has been finished, the CPU 302 immediately finishes obtaining the head temperature Tx in S1308. That is, the CPU 302 does not update the head temperature history T after finishing the printing operation. Then, in S1309, the CPU 302 starts a process as a first timing unit that obtains a first elapsed time Q elapsed since the end of the printing operation. In the present embodiment, the CPU 302 obtains the first elapsed time Q every 5 seconds and stores the obtained elapsed time in the non-volatile memory area in the printing apparatus 100. Thereafter, the CPU 302 performs a maintenance process such as preliminary ejection and wiping as necessary in S1310 as in the first embodiment, and then performs a capping operation in S1311 as in the first embodiment. After completing the capping operation, the CPU 302 finishes the operation of obtaining the first elapsed time Q and storing it in the non-volatile memory area and resets the value of the first elapsed time Q to 0 in S1312. Then, in S1313, the CPU 302 stops driving the circulation pumps 408, and terminates the printing operation sequence.

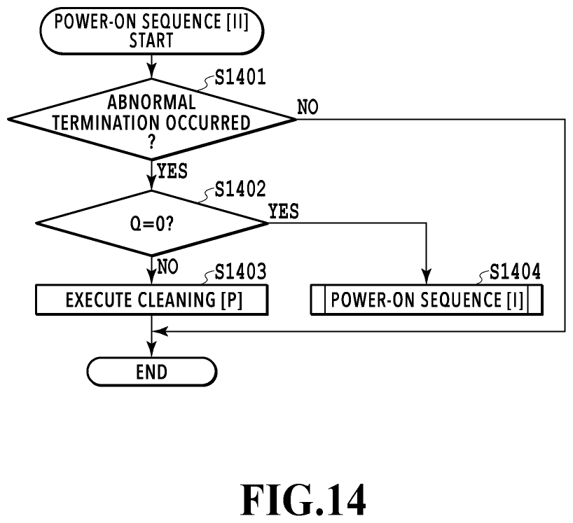

FIG. 14 is a flowchart illustrating a power-on sequence [II] (second recovery control) performed in the present embodiment. In FIG. 14, in a case where the user presses the power button provided in the operation panel of the printing apparatus 100 (turning on the power), the CPU 302 determines in S1401 whether abnormal termination occurred in the printing apparatus 100 in the operation before the power-on. If determining that abnormal termination did not occur, the CPU 302 terminates the power-on sequence [II]. The operation before the power-on mentioned here includes a series of operations executed in response to the last power-on. This series of operations include a printing operation on a print medium as well as predetermined operations performed after finishing the printing operation, i.e., operations executed after determining that the printing operation has been finished in S1307 in FIG. 13. The predetermined operations include, for example, cutting of the print medium on which an image has been printed, wiping, and the like while the operations may vary depending on how the printing apparatus 100 is used and caused to operate.

If, on the other hand, determining in S1401 that abnormal termination occurred in the operation before the power-on, the CPU 302 proceeds to S1402. In S1402, the CPU 302 refers to the value of the first elapsed time Q, and proceeds to S1403 if Q=0. If not Q=0, the CPU 302 proceeds to S1404, and executes the power-on sequence [I] described in the first embodiment. The first elapsed time Q is the time elapsed since the end of a printing operation, as mentioned earlier. Thus, in a case where abnormal termination occurred and the first elapsed time Q=0, it means that the abnormal termination occurred in a printing operation, i.e., in a period in which the print head 110 operated. Hence, if determining in S1402 that the first elapsed time Q=0, the CPU 302 executes the power-on sequence [I] described in the first embodiment. Specifically, the CPU 302 selects the cleaning [A], [B], [C], or [D] based on the temperature (temperature history T) at the abnormal termination that occurred in the printing operation and the time elapsed since the abnormal termination until the power-on.

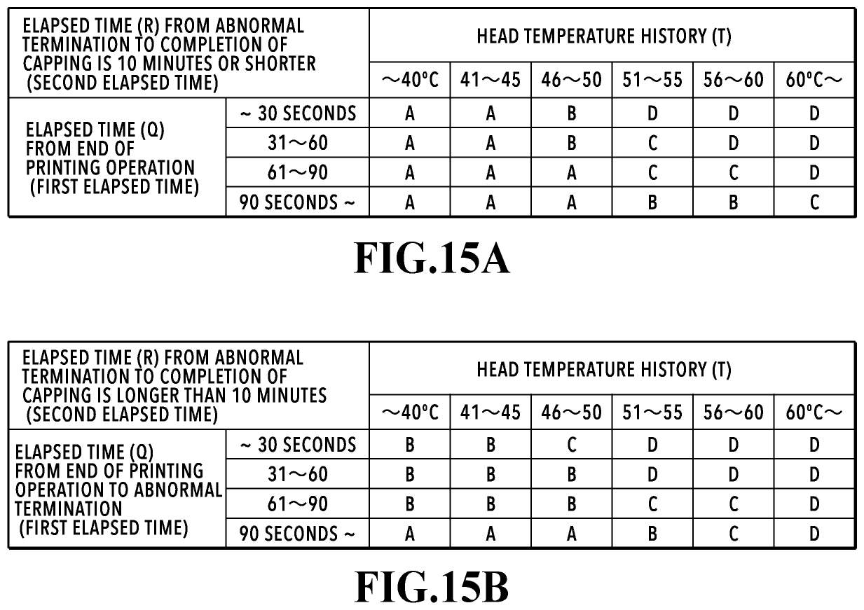

If, on the other hand, determining in S1402 that the first elapsed time Q 0, the CPU 302 proceeds to S1403 and executes cleaning [P]. FIGS. 15A and 15B illustrate details of the cleaning [P].

FIGS. 15A and 15B are diagrams illustrating the types of cleaning [P] that can be executed in S1403. Letters A, B, C, and D in the diagrams denote the types of cleaning [A], [B], [C], and [D] described in the first embodiment (see FIG. 11), respectively. In the present embodiment, the type of cleaning to be executed is selected based on an elapsed time R since the abnormal termination until the power-on (hereinafter referred to as “second elapsed time R”), the head temperature history T, and the first elapsed time Q, and is executed. The second elapsed time R is obtained by the CPU 302. In other words, the CPU 302 functions as a second timing unit that obtains the second elapsed time.

FIG. 15A illustrates the types of cleaning that can be executed in a case where the second elapsed time R, which is the time elapsed since the abnormal termination until the power-on, is 10 minutes or shorter. As mentioned in the first embodiment, the degree of thickening and solidification of the inks in the ejection ports 424 progresses the higher the head temperature (head temperature history T) at abnormal termination. For this reason, cleaning with higher recovery strength, i.e., cleaning with a larger ink suction amount, is executed for a higher head temperature history T.

The first elapsed time Q, on the other hand, represents the time elapsed since the end of the obtaining of the head temperature Tx in S1308 in FIG. 13 (the end of the printing operation) until the occurrence of the abnormal termination. As illustrated in FIG. 13, from S1308, no printing operation is performed. Accordingly, the head temperature decreases from the one at the abnormal termination the longer the first elapsed time Q due to heat dissipation. Accordingly, the ink suction amount necessary for the print head 110 to recover appropriate ejection performance decreases the longer the first elapsed time Q. Incidentally, in the present embodiment, preliminary ejection is performed in the maintenance process in S1310. Hence, strictly speaking, the head temperature rises due to this preliminary ejection. Nonetheless, the preliminary ejection performed in this process takes only a short time, so that the rise in head temperature is small and does not affect the selection of the type of cleaning necessary for the abnormal termination.

FIG. 15B illustrates the types of cleaning that can be executed in a case where the second elapsed time R is longer than 10 minutes. The evaporation of the volatile component in the inks progresses the longer the time elapsed since the abnormal termination until the power-on (second elapsed time R). For this reason, as illustrated in FIG. 15B, in the case where the second elapsed time is longer than 10 minutes, cleaning with higher recovery strength than that in the case where the second elapsed time is 10 minutes or shorter is executed. For example, the cleaning [A] is executed in a case where the second elapsed time is 10 minutes or shorter on condition that the head temperature history T at the abnormal termination is 41° C. to 45° C. and the first elapsed time is 31 seconds to 60 seconds. On the other hand, in a case where the second elapsed time is longer than 10 minutes with the same head temperature history T at the abnormal termination and the same first elapsed time, the cleaning [B] with higher recovery strength than that of the cleaning [A] is executed.

As described above, in the present embodiment, the obtaining of the head temperature and the update of the head temperature history are stopped in response to finishing a printing operation. In a case where abnormal termination occurs after the end of the printing operation, the type of cleaning is determined based on the head temperature history T obtained at the end of the printing operation and the first elapsed time Q. In other words, this means that the head temperature at the abnormal termination is estimated from the head temperature (head temperature history T) at the end of the printing operation and the time elapsed since the end of the printing operation until the abnormal termination (first elapsed time Q). Thus, according to the present embodiment, in which the head temperature is obtained by estimating the time from a printing operation to abnormal termination, it is possible to greatly reduce the load required for the process of obtaining the temperature as compared to a case of continuing obtaining the temperature detected by a sensor and updating the head temperature history even after the end of the printing operation. Moreover, in the present embodiment, the cleaning to be executed is selected based on the estimated head temperature and the second elapsed time R. Hence, it is possible to select appropriate cleaning with the ink temperature at the abnormal termination and the elapsed time taken into account. Accordingly, it is possible to appropriately recover the ejection performance of the print head while reducing unnecessary ink discharge.

### Other Embodiments

In the above embodiments, examples in which whether abnormal termination occurred is determined when the power is turned on have been described, but the present disclosure is not limited these examples. For example, with a printing apparatus capable of solving abnormality without its power turned off, it is possible to determine whether abnormal termination occurred in response to a resume instruction input automatically or by a user operation after solving abnormality.

Also, the above embodiments have been described taking a serial printing apparatus of a circulation type as an example which supplies and collects inks by means of the buffer tanks 401 of the print head 110 mounted on the carriage 102, but the present disclosure is not limited to this configuration. The present disclosure is also applicable to printing apparatuses not employing the circulation type. Specifically, the present disclosure is also applicable to serial printing apparatuses of a type which includes a print head and ink cartridges mounted on a carriage and supplies inks to the print head from the ink cartridges. Moreover, the present disclosure is applicable to full-line printing apparatuses which performs a printing operation while holding a print head at a fixed position and continuously conveying a print medium.

Furthermore, in the above embodiments, examples have been described in which cleaning is performed by generating a negative pressure in the caps 511, which are capable of coming into and out of contact with the print head 110, and thereby sucking the inks out of the ejection ports 424. Alternatively, another method can be employed as the cleaning. For example, a pressurization recovery process can be executed as the cleaning in which a positive pressure is applied into the print head to thereby forcibly discharge the inks from the ejection ports with that positive pressure.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-111796, filed Jul. 12, 2022 which is hereby incorporated by reference wherein in its entirety.

What is claimed is:

1. A liquid ejection apparatus, comprising:
a liquid ejection head that performs an ejection operation of ejecting a liquid from an ejection port;
a cap movable to a closed position at which the cap covers the ejection port and an open position at which the cap does not cover the ejection port;
a temperature obtaining unit configured to obtain a temperature of the liquid ejection head;
a recovery unit configured to perform a recovery process of recovering liquid ejection performance of the liquid ejection head; and
a control unit configured to, in a case where a power of the liquid ejection apparatus is turned on after the power is turned off with the cap at the open position, control the recovery process based on the temperature obtained by the temperature obtaining unit before the power-off.

2. The liquid ejection apparatus, according to claim 1, wherein
the temperature obtaining unit regularly obtains the temperature of the liquid ejection head during the ejection operation of the liquid ejection head, and
the control unit controls the recovery process based on a highest temperature among temperatures obtained by the temperature obtaining unit before the power-off.

3. The liquid ejection apparatus, according to claim 1, wherein the control unit controls the recovery process based on the temperature of the liquid ejection head before the power-off and a first elapsed time from the power-off to the subsequent power-on.

4. The liquid ejection apparatus, according to claim 1, wherein the control unit
in a case where the power-off occurred in the ejection operation, performs first recovery control that controls the recovery process based on the temperature obtained by the temperature obtaining unit at occurrence of the power-off and a second elapsed time from an end of the ejection operation to the power-off, and
in a case where the power-off occurred after the end of the ejection operation, performs second recovery control that controls the recovery process based on the temperature of the liquid ejection head at the end of the ejection operation, the second elapsed time, and a third elapsed time from the power-off to the power-on.

5. The liquid ejection apparatus, according to claim 1, wherein
the recovery unit performs a recovery process that forcibly discharges the liquid from the ejection port of the liquid ejection head, and
the control unit controls an amount of the liquid to be discharged in the recovery process.

6. The liquid ejection apparatus, according to claim 5, wherein
the recovery unit includes:
the cap; and
a negative pressure generation unit configured to generate a negative pressure inside the cap, and
the recovery unit forcibly discharges the liquid from the ejection port by generating the negative pressure inside the cap with the negative pressure generation unit with the cap at the closed position.

7. The liquid ejection apparatus, according to claim 6, wherein
the negative pressure generation unit is a suction pump communicating with the cap, and
the control unit controls at least one of a driving amount and a driving speed of the suction pump.

8. The liquid ejection apparatus, according to claim 1, wherein the liquid ejection head includes:
a channel communicating with the ejection port; and
a driving unit configured to cause the liquid supplied to the channel to flow.

9. The liquid ejection apparatus, according to claim 1, wherein the liquid ejection head includes:
a channel communicating with the ejection port;
a liquid holding unit communicating with the channel; and
a circulation pump for supplying the liquid from the liquid holding unit to the channel and collecting the liquid from the channel to the liquid holding unit.

10. The liquid ejection apparatus, according to claim 1, wherein the liquid contains at least a resin with a glass transition point of 120° C. or lower.

11. The liquid ejection apparatus, according to claim 1, wherein the liquid ejection head is mounted on a carriage that moves along a main scanning direction relative to a print medium conveyed in a predetermined conveyance direction by a conveyance unit, the main scanning direction crossing the conveyance direction.

12. The liquid ejection apparatus, according to claim 1, wherein the temperature obtaining unit is provided to the liquid ejection head.

13. A control method of a liquid ejection apparatus including a liquid ejection head that ejects a liquid from an ejection port and a cap movable to a closed position at which the cap covers the ejection port and an open position which is separated from the closed position and at which the ejection port is open, the control method comprising:
obtaining a temperature of the liquid ejection head;
performing a recovery process of recovering liquid ejection performance of the liquid ejection head; and
in a case where a power of the liquid ejection apparatus is turned on after the power is turned off with the cap at the open position, controlling the recovery process based on the obtained temperature before the power-off.

14. The control method according to claim 13, wherein
the obtaining a temperature includes regularly obtaining the temperature of the liquid ejection head during an ejection operation of the liquid ejection head, and
the controlling includes controlling the recovery process based on a highest temperature among temperatures obtained in the obtaining a temperature before the power-off.

15. The control method according to claim 13, wherein the controlling includes controlling the recovery process based on the temperature of the liquid ejection head before the power-off and a first elapsed time from the power-off to the subsequent power-on.

16. The control method according to claim 13, wherein
the controlling includes
in a case where the power-off occurred in the ejection operation, performing first recovery control that controls the recovery process based on the temperature obtained in the obtaining a temperature at occurrence of the power-off and a second elapsed time from an end of the ejection operation to the power-off, and
in a case where the power-off occurred after the end of the ejection operation, performing second recovery control that controls the recovery process based on the temperature of the liquid ejection head at the end of the ejection operation, the second elapsed time, and a third elapsed time from the power-off to the power-on.

17. The control method according to claim 13, wherein
the performing a recovery process includes performing a recovery process that forcibly discharges the liquid from the ejection port of the liquid ejection head, and
the controlling includes controlling an amount of the liquid to be discharged in the recovery process.

18. The liquid ejection apparatus, according to claim 17, wherein the performing a recovery process includes forcibly discharging the liquid from the liquid ejection port by generating a negative pressure inside the cap at the closed position.

19. The liquid ejection apparatus, according to claim 10, wherein the controlling includes controlling at least one of a driving amount and a driving speed of a suction pump communicating with the cap.

20. A non-transitory computer-readable storage medium storing a program for causing one or more processors of a computer to execute a control method of a liquid ejection apparatus including a liquid ejection head that ejects a liquid from an ejection port and a cap movable to a closed position at which the cap covers the ejection portand an open position which is separated from the closed position and at which the ejection port is open, the control method comprising:
obtaining a temperature of the liquid ejection head;
performing a recovery process of recovering liquid ejection performance of the liquid ejection head; and
in a case where a power of the liquid ejection apparatus is turned on after the power is turned off with the cap at the open position, controlling the recovery process based on the obtained temperature before the power-off.
